(19) United States
(12) Patent Application Publication
(10) Pub. No.: US 2015/0066645 A1
(43) Pub. Date: Mar. 5, 2015

(54) Enhancing Marketing Funnel Conversion Through Intelligent Social Tagging and Attribution

(71) Applicant: International Business Machines Corporation, Armonk, NY (US)

(72) Inventors: Sachin Mahajan, Pune (IN); John Elbert Moore, JR., Brownsburg, IN (US)

(73) Assignee: International Business Machines Corporation, Armonk, NY (US)

(21) Appl. No.: 14/018,665

(22) Filed: Sep. 5, 2013

(51) Int. Cl. G06Q 30/02; G06Q 50/00

(52) U.S. Cl. CPC G06Q 30/0256; G06Q 50/01
USPC 705/14.54

(57) ABSTRACT

An embodiment of the invention provides a method and system for enhancing marketing funnel conversion through intelligent social tagging and attribution. A processor identifies search terms entered into a search engine and websites visited in response to web searches for the search terms. A compiler extracts consumer annotations from the websites visited, wherein the consumer annotations are generated by individuals who previously visited the websites and reviewed products on the websites. The compiler also extracts product specifications from the websites visited, wherein the product specifications are created by a seller and/or manufacturer of a product. The search terms, the websites visited, the extracted consumer annotations, and the product specifications are saved in an electronic database. An access controller permits access to the search terms, the websites visited, the extracted consumer annotations, and the product specifications to potential consumers.

### BACKGROUND

The present invention is in the field of systems, methods, and computer program products for enhancing marketing funnel conversion through intelligent social tagging and attribution.

A marketing funnel examines the marketing and sales processes of a company or organization. The marketing funnel describes a customer's movement starting from the moment that first contact is made with the customer until the purchase is made by the customer. The stages of the marketing funnel can include awareness, opinion, consideration, preference, and purchase.

### SUMMARY OF THE INVENTION

An embodiment of the invention provides a method and system for enhancing marketing funnel conversion through intelligent social tagging and attribution. A processor identifies search terms entered into a search engine and websites visited in response to web searches for the search terms. A compiler extracts consumer annotations from the websites visited, wherein the consumer annotations are generated by individuals who previously visited the websites and reviewed products on the websites. The compiler also extracts product specifications from the websites visited, wherein the product specifications are created by a seller and/or manufacturer of a product. The search terms, the websites visited, the extracted consumer annotations, and the product specifications are saved in an electronic database. The electronic database is located in a local device of a user and/or in a central data repository that is remotely located with respect to the local device. An access controller permits access to the search terms, the websites visited, the extracted consumer annotations, and the product specifications to a user.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method to enhance marketing funnel conversion through intelligent social tagging and attribution according to an embodiment of the invention;

FIG. 2 is a diagram illustrating a system to enhance marketing funnel conversion through intelligent social tagging and attribution according to an embodiment of the invention;

FIG. 3 is a flow diagram illustrating a method to enhance marketing funnel conversion through intelligent social tagging and attribution according to another embodiment of the invention

FIG. 4 is a flow diagram illustrating a method for electronic commerce according to an embodiment of the invention; and

FIG. 5 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a method and system to increase the throughput of the marketing funnel through intelligent tagging. More specifically, details for what a shopper is looking for online is collected, such as search terms, tags, attributes, sellers, reviews, other metadata, etc. The shopper details can be stored locally in a repository/database, which can be in a container on the local machine. With the consent of the shopper, the shopper details can be grouped/associated as a collection of resources for other potential buyers as an aid in the purchase process of the product or a similar type product.

The system can provide advantages for both the seller and potential buyers. For example, sellers can have materials, reviews, and purchasing information of their products available on a third-party host for review and consideration by potential buyers. On the other hand, potential buyers can have a plethora of information readily available that is related to the product and/or services they are looking for, thereby saving the time and effort needed to search through massive resources of data in order to aid in the purchase.

At least one embodiment of the invention includes a container (also referred to herein as a “database” or “repository”) of information that is sourced by other buyers, wherein the information can be shared with potential buyers for a given product or service. The collection of information can be used in searching for product information, reviews, options, websites visited, tagging, potential prices and retailers/wholesalers as it relates to a user's consideration for the purchase of a product. As described below, future purchasers of the same product or service can shortcut other elements of the marketing funnel (also referred to herein as the “purchasing funnel”) steps. The container can be located on a local device (e.g., workstation, Smartphone, tablet computer, etc.) and/or accessible (e.g., wirelessly) from a remote location (e.g., a server in another state or country).

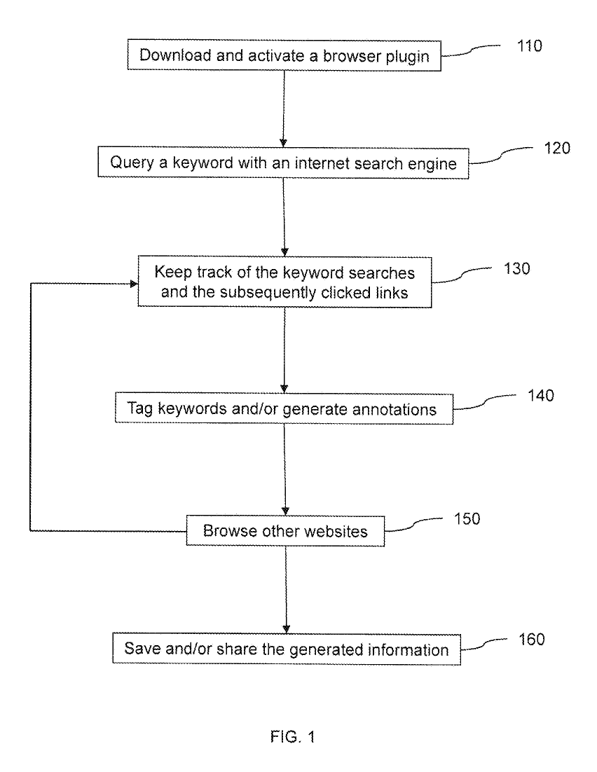

The following provides an example implementation of a system and method to enhance marketing funnel conversion according to an embodiment of the invention. A user is a homeowner searching for air conditioning products. The user conducts an internet word search for “air conditioning” and is presented with web advertisements (e.g., pop-up advertisements, banner advertisements) from several e-commerce companies, including AC Corporation. He does an organic branded search and visits the AC Corporation website, looks at a few products, and leaves before making a decision. He reads some reviews on an affiliate site for some generic products, returns to the AC Corporation website, and identifies a product on the AC Corporation website he wants to purchase. The user finds the product he is looking for on the affiliate site and eventually completes the transaction on the affiliate site. FIG. 1 is a flow diagram illustrating how the system and method works by describing the above use case.

A user downloads and activates a browser plugin, also referred to herein as the “tagged attribution plugin” 110. In another embodiment, a smart application (referred to herein as the “tagged attribution Smart App”) is used instead of the browser plugin. To begin his search for air conditioning products/equipment, he utilizes an internet search engine to query the basic keyword “air conditioning” 120. The tagged attribution plugin keeps track of the keyword searches and the subsequently clicked links 130. All of this information can be stored locally in the web browser as tags with the associated resources and the universal resource locators (URLs) of the websites visited.

The user comes across the “AC Corporation” website during his organic search, browses some of the products, and tags keywords and/or annotations with the tagged attribution plugin 140. For instance, the user can highlight keyword(s) on the webpage(s) (e.g., “energy”, “warranty”, “environmental”, etc.) and direct the tagged attribution plugin to tag them along with annotations expressing his comments about how the product or service will or will not fit his requirement. Another component in the tagged attribution plugin is the attribution definition, which includes user definitions of various products and/or services. For example, if a user is searching for a smart phone, the definition can include battery life/talktime, screen size, resolution, etc. For refrigerators, the definition can include height, width, door type, star rating, etc. The tagged attribution plugin can use these definitions to tag implicit information about the product, reviews, comments or user driven annotations to be populated along with other information already stored. The attribution definition can be collected from users before or after the tagged attribution plugin is activated.

The user continues to browse other websites 150; and, items 130 and 140 are repeated. When a purchase transaction is made, the user is given an option to save and/or share the generated information through a hosted service 160. In at least one embodiment, the tagged attribution plugin keeps track of all search terms used in the search engine as well as websites visited, for either reference materials, reviews, product information, pricing, etc. All of these items can also be stored, along with any other relevant information and notes, in the same container.

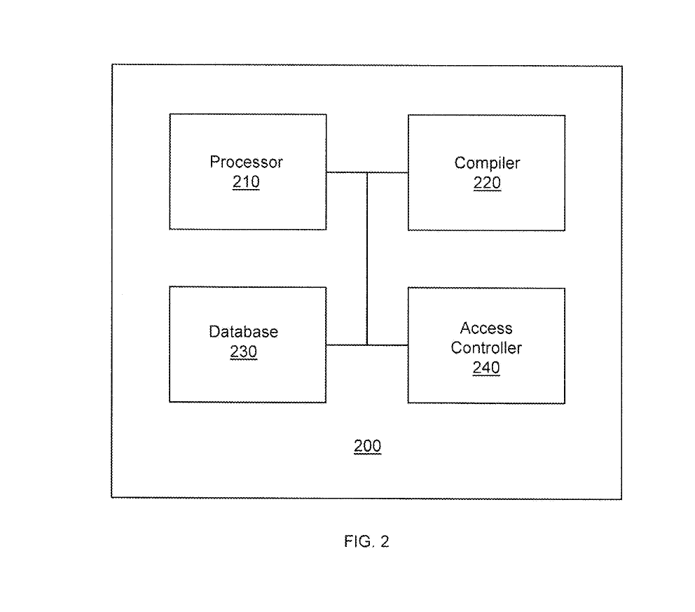

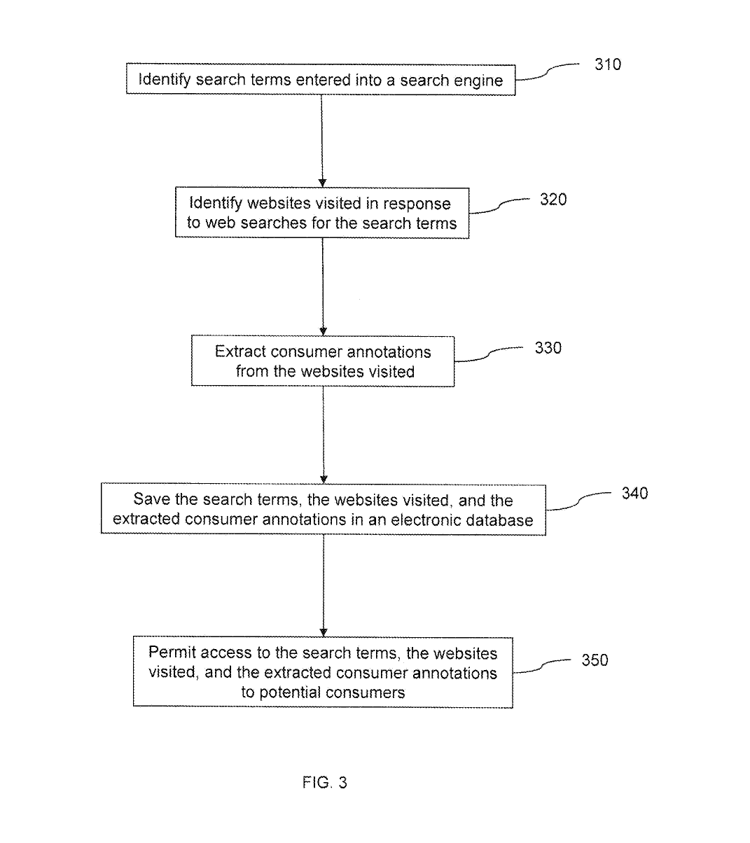

FIG. 2 is a diagram illustrating a system 200 to enhance marketing funnel conversion through intelligent social tagging and attribution according to an embodiment of the invention. The system 200 (also referred to herein as the “tagged attribution plugin”) includes a processor 210, a compiler 220, an electronic database 230, and an access controller 240. FIG. 3 is a flow diagram illustrating a method to enhance marketing funnel conversion, for example, using the system 200. As used herein, the term “processor” includes a computer hardware device that identifies search terms entered into a search engine 310. In at least one embodiment, the processor 210 can monitor/analyze online behavior of select groups of individuals based on their demographic (e.g., age, gender, geographic location, income, and/or education). For example, the processor 210 identifies that the search terms “computer”, “laptop”, and “tablet” are entered by male individuals between the ages of 20-30 years old. In at least one embodiment, an individual's demographic information is obtained from a log-in profile and/or IP address.

The processor 210 also identifies websites visited in response to web searches for the search terms (i.e., hyperlinks selected on a webpage that resulted from an internet search) 320. For instance, after performing an internet search for the term “laptop”, a user selects the first three search results. The search results (i.e., hyperlinks, websites) selected by the user are identified by the processor 210. In at least one embodiment of the invention, the processor 210 identifies websites that are visited which were not found via a search engine. For example, the processor 210 identifies websites that are visited by following an advertiser link and websites that are visited via manual entry of a URL into a web browser (e.g., www.abcmotors.com/xyzsedan).

As used herein the term “compiler” includes a computer hardware device that is connected to the processor 210. The term “connected” includes operationally connected, logically connected, in communication with, physically or wirelessly connected, engaged, coupled, contacts, linked, affixed, and attached. In another embodiment, the compiler 220 is a part of the processor 210. The compiler 220 extracts consumer annotations from the websites visited, wherein the consumer annotations are generated by individuals who previously visited the websites and reviewed products on the websites 330. In at least one embodiment, the compiler 220 copies the history of websites visited by an individual and the items downloaded (e.g., pdf files, videos) and stores them in the active container. When an individual highlights text on a website, a button can be pushed on the browser to store the text in the container.

In at least one embodiment, the consumer annotations include product reviews, such as online consumer comments directed towards a product. As used herein, the term “product” includes goods and/or services. For example, the consumer annotations can include consumer generated comments for a DVD player that are posted on a retailer's website, an online auction, and/or a shopping website. In another example, the consumer annotations can include consumer generated comments for a moving company that are posted on an online message board or a social networking website.

The consumer annotations can include product ratings (e.g., rating on a scale of 1-5, star rating) and/or product information. In one embodiment, the consumer annotations include content that is created by the seller of a product and/or a manufacturer of the product, wherein the content is tagged by at least one individual as useful or noteworthy content. For example, the consumer annotations can include a webpage showing product information, wherein the webpage is tagged by an individual because the product has won an award, the product is on sale, or because a new version of the product will be released soon.

The processor saves the search terms, the websites visited, and the extracted consumer annotations in an electronic database 230 (340). As used herein the term “electronic database” includes a computer hardware memory device that is connected to the processor 210 and/or the compiler 220. The electronic database 230 can be located on the local device of a user (e.g., Smartphone, tablet computer, laptop computer). In another embodiment, the electronic database 230 is a central data repository that is remotely located with respect to the user's device (e.g., a server in a datacenter).

The access controller 240 permits access to the search terms, the websites visited, and the extracted consumer annotations to potential consumers (also referred to herein as a “user”) 350. As used herein the term “access controller” includes a computer hardware device that is connected to the processor 210 and/or the electronic database 230.

For example, a potential consumer who is interested in purchasing a tablet computer can access the electronic database 230 to identify the websites that other consumers are visiting to shop for tablet computers. The potential consumer can also identify the search terms used by the other consumers, for example, the term “ABC tablet” has been searched for 1,824 times by other consumers and the term “XYZ tablet” has been searched for 12,024 times by other consumers. In addition, product reviews, product ratings, product specifications, and/or consumer annotations for numerous tablet computers can be readily available to the potential consumer on the electronic database 230. For example, the potential consumer can query the electronic database 230 for the term “table computers” and click on a “consumer annotations” tab or icon to display product ratings and content that is tagged by other consumers.

In at least one embodiment of the invention, the processor 210 extracts product specifications from the websites visited, wherein the product specifications are created by a seller of a product and/or a manufacturer of the product. The product specifications can include information such as processor speed, RAM, price, screen size, overall size, size dimensions, weight, etc. The product specifications can be saved in the electronic database 230 by the processor 210, wherein the access controller 240 can permit access to the product specifications to potential consumers.

The following provides an exemplary use of an embodiment of the invention, wherein the user is a homeowner who desires to purchase refrigeration and cooling goods. First, the user conducts a web search on air conditioning products, and is served pay-per-click advertisements from several e-commerce companies, including AC corporation. He then does an organic branded search and visits the AC Corporation website, looks at a few products, and leaves before making a decision. The user reads some reviews on an affiliate site for some generic products, comes back to the AC Corporation website and identifies a product to buy. He finds the product he is looking for and eventually completes the transaction on the affiliate site.

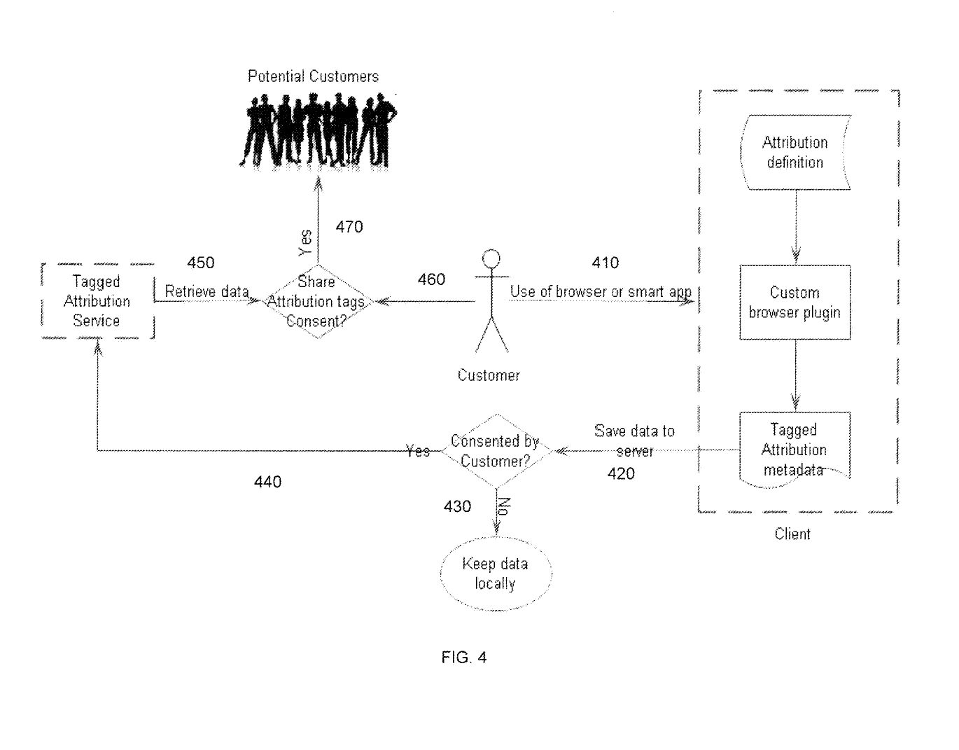

FIG. 4 illustrates the above use case according to an embodiment of the invention. The user downloads and activates a browser plugin (e.g., “Tagged attribution plugin”) or a smart application (e.g., “Tagged attribution Smart App”). Using basic keyword searches on an internet search engine, the user begins his search for air conditioning products 410.

The Tagged attribution plugin keepings track of the keyword searches performed by the user and the hyperlinks that are subsequently selected by the user. All of this information can be stored locally in the browser as tags with the associated resources and URLs. In at least one embodiment, the tags described herein are different from the conventional tags that are provided on some websites, which are relevant and have to be created on that domain.

The user comes across the AC Corporation website during an organic internet search and starts browsing some of the AC Corporation's products. He highlights some keywords on the page and directs the “Tagged attribution plugin” to tag the keywords along with annotations expressing his comments about how the selected product(s) will or will not satisfy his requirements.

Another component in the “Tagged attribution plugin” is the Attribution definition, wherein user definitions of various products can be stored. For instance, if the user is conducting research for the purchase of a smart phone, the definition could include items such as battery life/talk-time, screen size, screen resolution, memory, operating system, etc. If the user is conducting research for the purchase of a refrigerator, the definition could include height, width, weight, door type, energy star rating, etc. The Tagged attribution plugin can use these definitions to tag implicit information about the product, reviews, comments, and/or user driven annotations to be populated along with other information already stored. The user continues to browse on other websites that can be affiliated with the AC Corporation. The steps of tracking keyword searches and the subsequently clicked links and tagging can be repeated.

When the transaction is made by the user 420, the user is given an option to save the generated information locally 430 (e.g., on the user's desktop computer) and/or to share the information through a hosted service 440 (e.g., the tagged attribution service). The information generated by the user is retrieved from the hosted service 450 for use by other potential consumers 470 when the user gives consent 460. In another embodiment of the invention, all of the search terms used in a search engine are tracked, in addition to the websites visited for reference materials, reviews, product information, pricing, etc. All of these items can also be stored, along with any other relevant information and notes, in a container.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

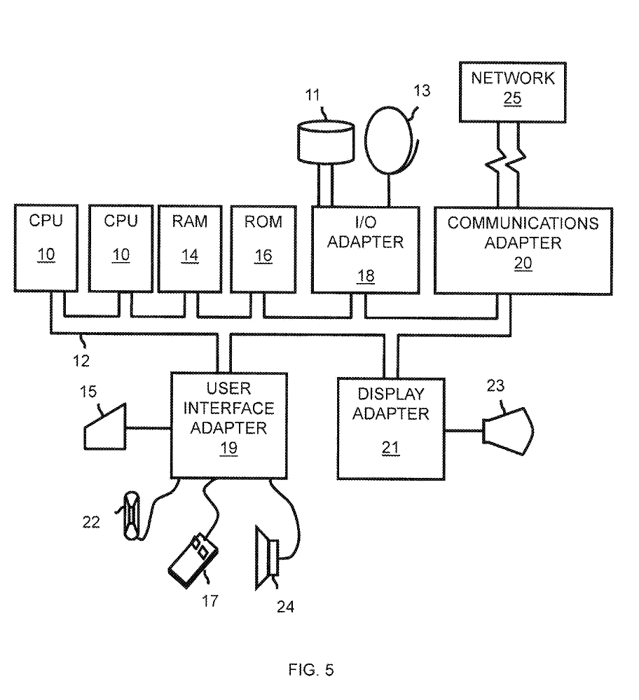

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 12 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
identifying, with a processor, search terms entered into a search engine;
identifying, with the processor, websites visited in response to web searches for the search terms;
extracting with a compiler any consumer annotations present on the websites visited, the consumer annotations generated by individuals who previously visited the websites;
saving the search terms, the websites visited, and the extracted consumer annotations in an electronic database; and
permitting, with an access controller, access to the search terms, the websites visited, and the extracted consumer annotations to a user.

2. The method according to claim 1, wherein the consumer annotations include product reviews.

3. The method according to claim 1, wherein the consumer annotations include product ratings.

4. The method according to claim 1, wherein the consumer annotations include content that is tagged by at least one individual.

5. The method according to claim 1, wherein the consumer annotations include product information.

6. The method according to claim 1, wherein the consumer annotations include:
product reviews;
product ratings; and
content that is created by at least one of a seller of a product and a manufacturer of the product that is tagged by at least one individual.

7. The method according to claim 1, further comprising:
extracting product specifications from the websites visited, the product specifications created by at least one of a seller of a product and a manufacturer of the product;
saving the product specifications in the electronic database; and
permitting access to the product specifications to a user.

8. The method according to claim 1, wherein the saving of the search terms, websites visited, and extracted consumer annotations includes saving the search terms, websites visited, and extracted consumer annotations in at least one of:
a local device of a user; and
a central data repository that is remotely located from the local device.

9. A method comprising:
identifying, with a processor, search terms entered into a search engine;
identifying, with the processor, websites visited in response to web searches for the search terms;
extracting, with a compiler, consumer annotations from the websites visited, the consumer annotations generated by individuals who previously visited the websites and reviewed products on the websites;
extracting product specifications from the websites visited, the product specifications created by at least one of a seller of a product and a manufacturer of the product;
saving, with the processor, the search terms, the websites visited, the extracted consumer annotations, and the product specifications in an electronic database, the electronic database being located in at least one of:
a local device of a user; and
a central data repository that is remotely located with respect to the local device; and
permitting, with an access controller, access to the search terms, the websites visited, the extracted consumer annotations, and the product specifications to a user.

10. The method according to claim 9, wherein the consumer annotations only include product reviews.

11. The method according to claim 9, wherein the consumer annotations only include product ratings.

12. The method according to claim 9, wherein the consumer annotations only include content that is created by at least one of a seller of a product and a manufacturer of the product that is tagged by at least one individual as at least one of useful content and noteworthy content.

13. The method according to claim 9, wherein the consumer annotations only include product information.

14. A system comprising:
a processor, the processor identifies search terms entered into a search engine and websites visited in response to web searches for the search terms;
a compiler connected to the processor, the compiler extracts consumer annotations from the websites visited, where the consumer annotations generated by individuals visiting the websites;
an electronic database connected to the processor, the electronic database stores the search terms, the websites visited, and the extracted consumer annotations; and
an access controller connected to the electronic database, the access controller permits access to the search terms, the websites visited, and the extracted consumer annotations to a user.

15. The system according to claim 14, wherein the consumer annotations include product reviews.

16. The system according to claim 14, wherein the consumer annotations include product ratings.

17. The system according to claim 14, wherein the consumer annotations include content that is created by at least one of a seller of a product and a manufacturer of the product that is tagged by at least one individual.

18. The system according to claim 14, wherein the consumer annotations include product information.

19. The system according to claim 14, wherein the compiler extracts product specifications from the websites visited, the product specifications created by at least one of a seller of a product and a manufacturer of the product,
the electronic database stores the product specifications, and
the access controller permits access to the product specifications to a user.

20. The system according to claim 14, wherein the electronic database is located in at least one of:
a local device of a user; and
a central data repository that is remotely located with respect to the local device.
